(19) United States
(12) Patent Application Publication
(10) Pub. No.: US 2009/0277792 A1
(43) Pub. Date: Nov. 12, 2009

(54) Method for concentrating charged particles and apparatus thereof

(75) Inventors: Shau-Chun Wang, Chiayi City (TW); Hsueh-Chia Chang, Granger, IN (US); Hsiao-Ping Chen, Chiayi County (TW); Hsien-Hung Wei, Tainan City (TW); Chun-Ching Yu, Yongkang City (TW); Min-Hsuan Tsai, Taichung County (TW)

Correspondence Address: HUDAK, SHUNK & FARINE, CO., L.P.A., 2020 FRONT STREET, SUITE 307, CUYAHOGA FALLS, OH, 44221, US

(73) Assignee: NATIONAL CHUNG CHENG UNIVERSITY, CHIA-YI (TW)

(21) Appl. No.: 12/383,893

(22) Filed: Mar. 30, 2009

Related U.S. Application Data
(60) Provisional application No. 61/051,827, filed on May 9, 2008.

(51) Int. Cl. G01N 27/447; G01N 27/453

(52) U.S. Cl. 204/547; 204/643

(57) ABSTRACT

The present invention discloses a method for concentrating charged particles and an apparatus thereof. The method comprises: providing a substrate comprising a reservoir; disposing a conducting granule in the reservoir, the conducting granule being negatively charged or positively charged and comprising nano-pores or nano-channels capable of permitting ion permeation; disposing a buffer solution in the reservoir, the buffer solution comprising counter-ions having an opposite electric property to the conducting granule; adding the charged particles into the buffer solution, the charged particles being co-ions having an identical electric property as the conducting granule; and applying an external electric field on the conducting granule. While the external electric field is applied on the conducting granule, the counter-ions exit from the nano-pores or nano-channels and have a nonuniform concentration on a surface of the conducting granule such that a transient ion super-concentration phenomenon occurs at an ejecting pole on the conducting granule. Hence the present invention has potential application in bead-based molecular assays.

### BACKGROUND OF THE INVENTION

1. Field of the Invention

This invention relates to a method for concentrating charged particles and an apparatus thereof, and particularly to a method and apparatus capable of trapping and concentrating co-ion micro-colloids and applicable to bead-based molecular assays.

2. Description of Related Art

Field-induced polarization of particles and molecules is responsible for a variety of electric particle and molecular forces that permit particle manipulation, drive colloid self-assembly, and allow suspension characterization. Conventional Maxwell-Wagner theories attribute these electric induced dipoles to interfacial dielectric polarization that occurs at atomic, molecular, and particle times and length scales, and exhibit megahertz or higher dispersion frequencies. In electrolytes, there is considerable evidence that double-layer conduction around the particle, normal charging into the double-layer of thickness λ, and other polarization mechanisms involving currents, ion fluxes, electro-osmotic convection, and charge storage in double-layers are the more dominant polarization mechanisms than dielectric polarization. These double-layer polarization mechanisms are confined to the thin double-layers (of 10-100 nm) but nevertheless involve space charges. Empirical evidence for such double-layer polarization mechanisms includes the prevalence of the relaxation time aλ/D in many impedance and dielectrophoresis measurements which requires a conducting Stern layer. However, these lumped conductivity models do not capture local charge accumulation (capacitance) effects at certain locations within the double-layer.

### SUMMARY OF THE INVENTION

With these and other objects, advantages, and features of the invention that may become hereinafter apparent, the nature of the invention may be more clearly understood by reference to the detailed description of the present invention, the embodiments and to the several drawings herein.

The present invention provides a method and apparatus to concentrate charged particles by capturing local charge accumulation effects at a certain location within the double-layer on the surface of a conducting granule and the method and apparatus is able to apply to bead-based biomolecular assays.

The present invention discloses a method for concentrating charged particles, comprising the following steps. Firstly, a substrate comprising a reservoir may be provided and a conducting granule may be disposed in the reservoir. The conducting granule may be neither negatively charged or positively charged and comprise nano-pores or nano-channels permeable to ions. Then, a buffer solution may be disposed in the reservoir and the buffer solution comprises counter-ions having an opposite electric property to the conducting granule. Next, the charged particles may be added into the buffer solution. The charged particles may be co-ions having an identical electric property as the conducting granule. Finally, an external electric field mat be applied on the conducting granule, and thereon the counter-ions may exit from the nano-pores or nano-channels and produce a nonuniform concentration on a surface of the conducting granule such that a transient ion super-concentration phenomenon may occur at an ejecting pole on the conducting granule. The method may further comprise an electric double-layer formed on the surface of the conducting granule by the counter-ions. The pore size of the nano-pores may be roughly 3-5 times the double-layer thickness. In addition, the charged particles may comprise solute particles, such as fluorescent dye particles, or microparticles, such as micro-colloid particles. The method may be applicable to a bead-based biomolecular assay.

The present invention further discloses an apparatus for concentrating charged particles. The apparatus may comprise a substrate which may comprise a reservoir; a conducting granule which may be neither negatively charged or positively charged and comprise nano-pores or nano-channels able to permit ion permeation, and be disposed in the reservoir; a buffer solution which may comprise counter-ions having an opposite electric property to the conducting granule, and be disposed in the reservoir; and an external electric field which may applys on the conducting granule. Wherein, the charged particles may be co-ions having an identical electric property as the conducting granule and be added into the buffer solution. While the external electric field may be applied on the conducting granule, the counter-ions may exit from the nano-pores or nano-channels and have a nonuniform concentration on the surface of the conducting granule such that a transient ion super-concentration phenomenon may occur at an ejecting pole on the conducting granule. Additionally, the substrate may comprise a chip or a plastic plate amd the charged particles may comprise fluorescent dye particles or micro-colloid particles. The apparatus may be applicable to a bead-based biomolecular assay.

This present invention may involve a transient million-fold concentration of double-layer counter-ions at the ejecting pole of a mm-sized conducting nano-porous granule that permits ion permeation by applying a high-intensity electric field across the apparatus. This mechanism is also shown to trap and concentrate co-ion micro-colloids and hence has potential application in bead-based molecular assays.

The present invention also discloses the mechanism behind the transient ion super-concentration phenomenon at the ejecting pole and demonstrates that a six-order enhancement in the ion concentration may be achieved locally within the double-layer if the granule is permeable to ions, with a comparable enhancement of Maxwell-Wagner polarization. The dynamic super-concentration phenomenon may be attributed to a unique counter-ion screening dynamics that transforms half of the surface field into a converging one towards the ejecting pole. The resulting surface conduction flux may then funnel a large upstream electro-osmotic convective counter-ion flux into the injecting hemisphere towards the zero-dimensional gate of the ejecting hemisphere to produce the super concentration. When pore size of conducting granule may be roughly 3-5 times the buffer concentration-dependent double-layer thickness, the super concentration may happen.

In the present invention, the possibility of concentrating micro-colloids which are larger than the double-layer dimension is an intriguing possibility. The micro-colloids may be not expected to enter into the granule. However, co-ion micro-colloids can still be attracted to the concentrated counter-ions at the exit. Bead-based biomolecular assays have attracted considerable attention recently and the possibility of filtering and concentrating such functionalized or hybridized beads on a chip can be quite useful for such assays.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of a mechanism behind a transient ion super-concentration phenomenon in accordance with the present invention;

FIG. 2 illustrates a flowchart of a method for concentrating charged particles in accordance with the present invention;

FIG. 3 illustrates a schematic diagram of an apparatus for concentrating charged particles in accordance with one embodiment of the present invention;

FIG. 4 illustrates a schematic diagram of a fluorescence microscopy imaging apparatus in accordance with one embodiment of the present invention;

FIG. 5 illustrates sequential images of solute concentration evolution for a cation exchange resin granule in accordance with one embodiment of the present invention;

FIG. 6 illustrates a concentration intensity contour in the region highlighted in FIG. 3 in accordance with the present invention;

FIG. 7 illustrates a measured concentration factor in a jet area at different buffer concentrations for cation exchange resin granules and for wax beads in accordance with one embodiment of the present invention;

FIG. 8 illustrates a polar ejection for an anion exchange granule in accordance with one embodiment of the present invention; and

FIG. 9 illustrates sequential images of microparticle concentration evolution for a cation exchange resin granule in accordance with one embodiment of the present invention.

### DETAILED DESCRIPTION OF THE PREFERRED EMBODIMENTS

Exemplary embodiments of the present invention are described herein in the context of a method and apparatus for concentrating charged particles.

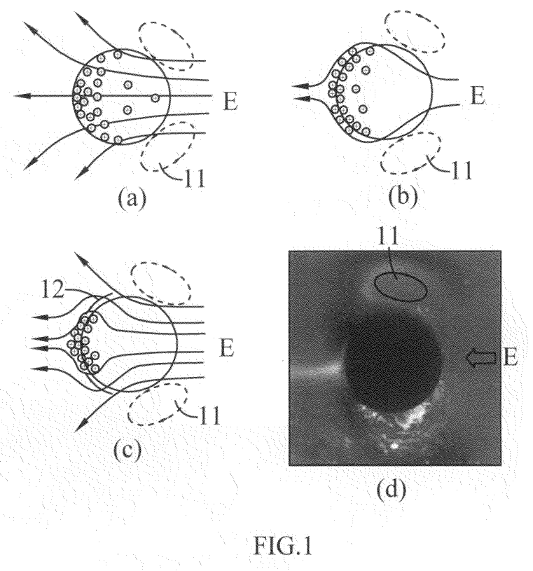

Please refer FIG. 1 in which illustrating a schematic diagram of a mechanism behind a transient ion super-concentration phenomenon in accordance with the present invention is illustrated. To concentrate space charges within a double-layer at a ejecting pole, a converging tangential flux from a granule toward the pole must be implemented as normal charging into this small polar region is insignificant. The requisite tangential field at the ejection hemisphere is produced by the screening effects of exiting counter-ions from the saturated granule, as seen in FIG. 1. A tangential counter-ion flux results at the ejecting hemisphere that must be sustained by an equally large tangential flux at the injecting hemisphere under the condition when the granule is permeable and cannot accumulate ions. Consequently, ion fluxes into and out of the granule are required for large polar concentration. As a general rule, pores with radii smaller than the double layer thickness tend to trap large amounts of counter-ions and would not release them to the exit hemisphere. This important pore size effect for super-concentration will be established hereinafter in the present invention. In detail, FIG. 1 shows the granule funnel: (a) convective charging of the granule by asymmetric vortices 11 at the right, (b) saturation of double layer by counter-ions exiting the granule and field screening, and (c) dynamic double-layer pinching 12 towards the ejection pole. FIG. 1(d) is a real image showing the polar ejection and the asymmetric vortices on the other hemisphere. One vortex 11 evidenced from the streak is highlighted.

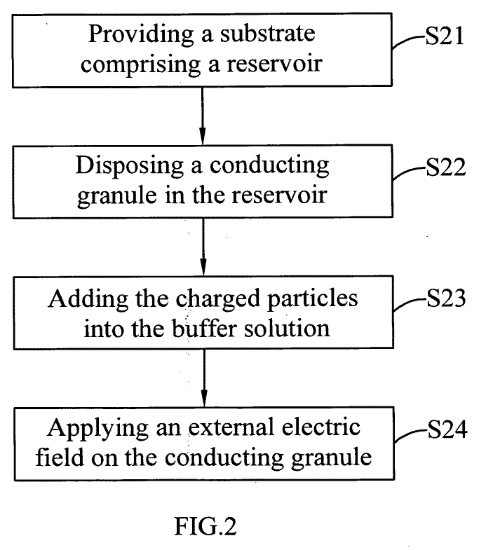

Please refer to FIG. 2 for a flowchart of a method for concentrating charged particles in accordance with the present invention. The method may comprise the following steps: step S21, providing a substrate comprising a reservoir; step S22, disposing a conducting granule in the reservoir, the conducting granule being negatively charged or positively charged and comprising nano-pores or nano-channels capable of permitting ion permeation; step S23, adding the charged particles into the buffer solution, the charged particles being co-ions having an identical electric property as the conducting granule; step S24, applying an external electric field on the conducting granule. While the external electric field is applied on the conducting granule, the counter-ions exit from the nano-pores or nano-channels and have a nonuniform concentration on a surface of the conducting granule so as to occur a transient ion super-concentration phenomenon at an ejecting pole on the conducting granule.

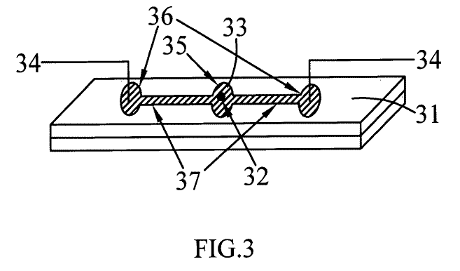

Please refer to FIG. 3 for a schematic diagram of an apparatus for concentrating charged particles in accordance with one embodiment of the present invention. The apparatus may comprise a substrate, such as a chip 31, a conducting granule 32, a buffer solution 33, and an external electric field 34. The substrate 31 may comprise a center reservoir 35 and two side reservoirs 36 and the center reservoir 35 may link to the two side reservoirs 36 by connection channels 37. The conducting granule 32 may be negatively charged or positively charged and comprise nano-pores or nano-channels permeable ions, and be disposed in the center reservoir 35. The buffer solution 33, such as Tris buffer solution, may comprise counter-ions having an opposite electric property to the conducting granule 32 and be disposed in the reservoirs 35 and 36. The external electric field 34 is produced by a pair of electrodes. Wherein, the charged particles are co-ions having an identical electric property as the conducting granule 32 and are added into the buffer solution 33, and while the external electric field 34 is applied on the conducting granule 32, the counter-ions exit from the nano-pores or nano-channels and have a nonuniform concentration on the surface of the conducting granule 32 such that a transient ion super-concentration phenomenon occurs at an ejecting pole on the conducting granule 32.

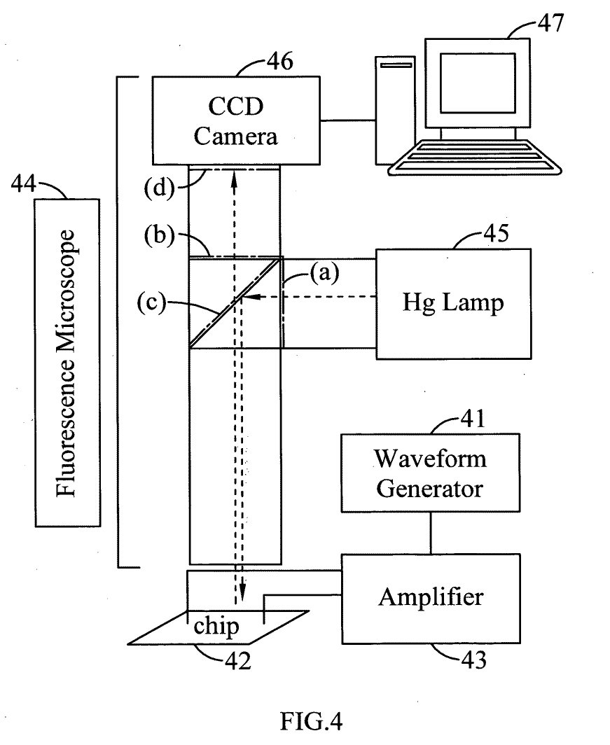

We image the enhanced counter-ion concentration not by, for example, counter-ions dye molecules, which may be too large to enter the nano-pores, but, for example, by fluorescent co-ion dye molecules which may neutralize the counter-ions at the exit of the granule and whose concentration is correspondingly enhanced at that location. An external electric field of about 100 V/cm may be applied on the mm-sized conducting granule made of polystyrene resins by a pair of electrodes. The pore size of the conducting granule may be 65 nm, or roughly 3-5 times the double-layer thickness of more concentrated buffer solutions (>0.1 mM). The granule can be either negatively charged (cation exchange) or positively charged (anion exchange). Fluorescence dye solution of cation (Rhodamine B) or anion (Fluorescein) in 10 mM pH buffers is filled in the reservoir prior to the field application. Net charges (mostly counter ions) released from the granule are immediately neutralized by co-ions (charged particles) in the bulk in a region close to the granule. Since co-ions as fluorescent dyes are employed to illuminate the phenomenon, an ejection reflects a local increase in the concentration in the neutral bulk close to the granule. The images are digitized and transferred into graphic analysis software, as shown in the FIG. 4. In the figure, a waveform generator 41 produces an external electric field to a chip 42 via an amplifier 43, and then fluorescence dye solution is illuminated by a fluorescence microscope 44 with mercury lamp 45 light source. The emitted fluorescence is detected with a charge-coupled device (CCD) camera 46 by recording the images of the process. After that, the images are digitized and transferred into graphic analysis software by a computer 47. Wherein, fluorescence microscopy imaging apparatus further comprises an excitation filer (a), an emission filer (b), a dichromatic mirror (c), and a 510 nm-530 nm bandpass filter (d).

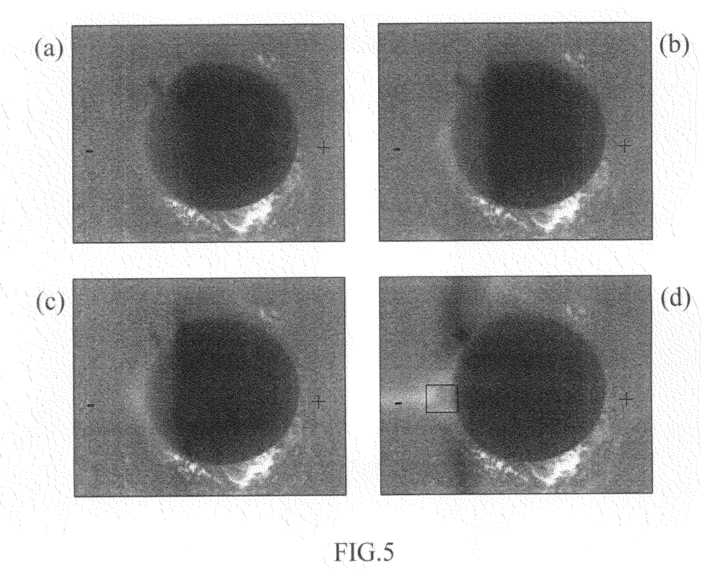

Sequential frames which are taken at 0, 0.36, 0.63, and 0.93 s in FIGS. 5a, 5b, 5c, and 5d respectively show the evolution of co-ion (Fluorescein) concentration processes under a step jump in the field strength 100 V/cm for the negatively charged granule with positive counter ions in the double layer. The lapsed frames capture the concentration of the anion dye towards the ejecting hemisphere to form a distinctive rim. The rim then focuses towards the exit pole close to the negative electrode. Upon reaching the pole, the dye concentrates and emits an intense fluorescent glow for an interval of 0.3 s before a violent ejection in the form of a jet occurs in FIG. 5d at 0.93 s.

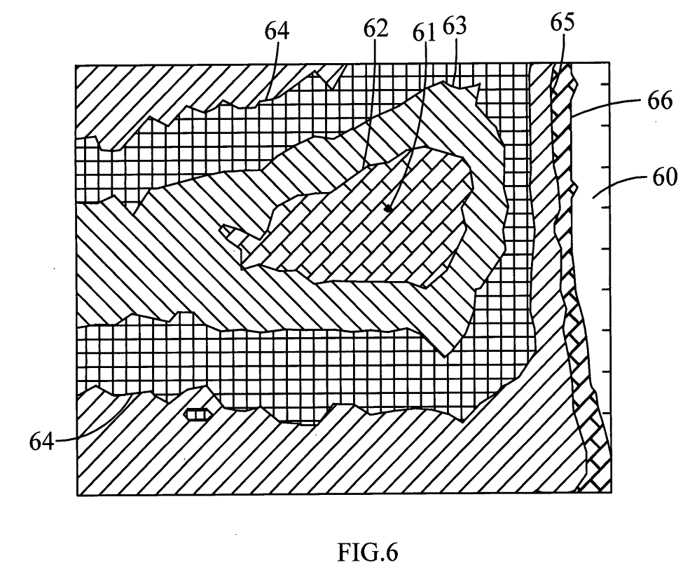

By subtracting the blank background (10 mM Tris buffer; pH 8) and correlating the reduced pixel intensity to the dye concentration, the concentration intensity contour in the region highlighted in FIG. 5d can be quantitatively estimated as FIG. 6. The numbers 61, 62, 63, 64, 65 and 66 on the concentration contour map indicate estimated molar concentrations of the dye, respectively being 0.2, 0.02, 0.002, 0002, 0.00002 and 0.000002. The white area 60 at the right side of the contour is the granule edge marked in the frame of FIG. 5d. The concentration is enhanced by ˜10⁶ and ˜10⁵ times the bulk value at the most concentrated spot and the jet area respectively.

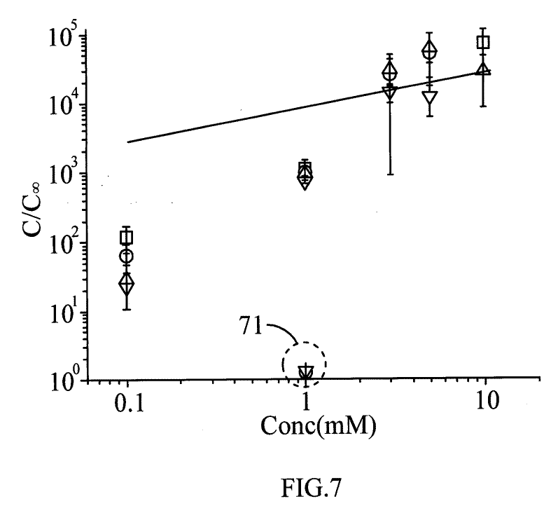

To underscore that ion permeation into the granule is necessary for this 10⁶-fold dynamic super-concentration, which was not observed in earlier steady-state experiments with smaller pores, the experiments at various ionic strengths and with a wax bead 71 of similar dimension are carried out. As seen in FIG. 7, the enhancement factor drops precipitously by one to two orders of magnitude at a concentration 0.1 mM, when the Debye length is estimated to be 30 nm and expected to be comparable to our pore size. There is no enhancement at all for the wax bead 71 without any pores. The higher conductivity data from 3 to 10 mM produce the 10⁵-fold concentration, suggesting the importance of permeation. When the Debye length is approximately equal to the pore size, the surface field is not screened and counter-ions with affinity for the surface functional groups condense readily onto the surface. As a consequence, the influx counter-ions are no longer able to migrate through the pore and therefore are captured within the granule.

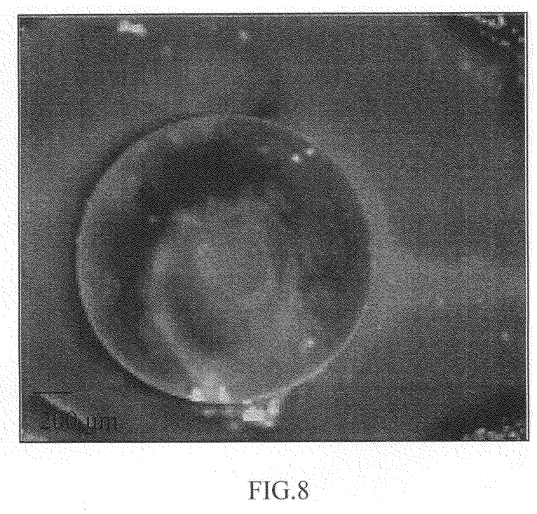

A similar co-ion concentration in the bulk region near the pole is observed when a positively charged granule is used with cationic dye Rhodamine B, as shown in the FIG. 8. In the figure, the polar ejection for anion exchange granule at 100 V/cm using co-ion Rhodamine B dyes (1 μM in 10 mM citrate buffer at pH 4) is taken at 0.96 s. Anionic counter-ions are absorbed onto the exit hemisphere to form a rim, which focuses toward the pole and ejects after a delay. The polar concentration and ejection phenomena are symmetric with respect to the granule and double layer polarity.

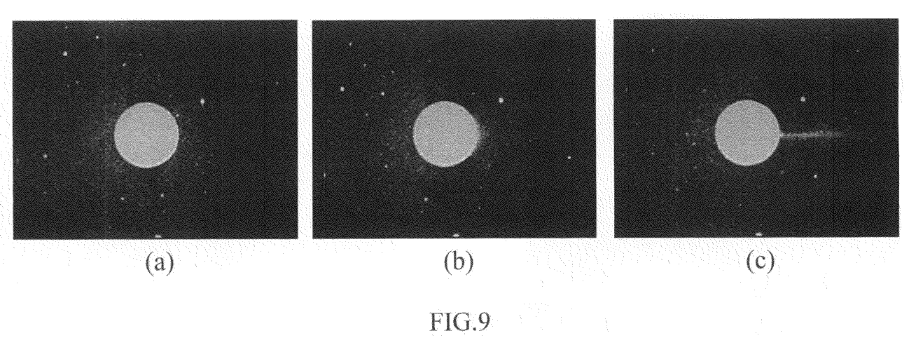

Similarly when a negatively charged granule is in the reservoir, the trapping of anionic microspheres tagged with fluorescein dyes is seen. The sequential images in FIG. 9 show fluorescein-tagged microspheres at very low density (5.0×10⁶ particles/mL) are concentrated with a step change in the field to 100 V/cm in 10 mM Tris buffer (pH 8) at the cation exchange granule exit pole. The concentrated particle density is estimated as 1.5×10⁸ particles/mL, as high as 30-fold concentration of the micro-colloids. The images are taken at 0, 1.35, and 2.44 s. Despite the fact that the micro-colloids do not enter or exit the granule. The reflection of the incoming light by the microspheres is much stronger than scattered light from the reservoir bottom in FIG. 3, thus preventing the latter from contaminating the image.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A method for concentrating charged particles, comprising the steps of:
providing a substrate comprising a reservoir;
disposing a conducting granule in the reservoir, the conducting granule being negatively charged or positively charged and comprising nano-pores or nano-channels capable of permitting ion permeation;
disposing a buffer solution in the reservoir, the buffer solution comprising counter-ions having an opposite electric property to the conducting granule;
adding the charged particles into the buffer solution, the charged particles being co-ions having an identical electric property as the conducting granule; and
applying an external electric field on the conducting granule;
wherein while the external electric field is applied on the conducting granule, the counter-ions exit from the nano-pores or nano-channels and have a nonuniform concentration on a surface of the conducting granule such that a transient ion super-concentration phenomenon occurs at an ejecting pole on the conducting granule.

2. The method according to claim 1, comprising an electric double-layer formed on the surface of the conducting granule by the counter-ions.

3. The method according to claim 2, wherein pore sizes of the nano-pores are 3-5 times a thickness of the electric double-layer.

4. The method according to claim 1, wherein the substrate comprises a chip or a plastic plate.

5. The method according to claim 1, wherein the conducting granule comprises a cation exchange resin granule or an anion exchange resin granule.

6. The method according to claim 1, wherein the charged particles comprise solute particles or microparticles.

7. The method according to claim 6, wherein the solute particles comprise fluorescent dye particles and the microparticles comprise micro-colloid particles.

8. The method according to claim 7, wherein the fluorescent dye particles comprise rhodamine B or fluorescein particles.

9. The method according to claim 1, wherein the external electric field is produced by a plurality of electrodes.

10. The method according to claim 1, wherein the method is applicable to a bead-based biomolecular assay.

11. An apparatus for concentrating charged particles, comprising:
a substrate, comprising a reservoir;
a conducting granule, being negatively charged or positively charged, comprising nano-pores or nano-channels capable of permitting ion permeation, and disposed in the reservoir;
a buffer solution, comprising counter-ions having an opposite electric property to the conducting granule, and disposed in the reservoir; and
an external electric field, applying on the conducting granule;
wherein, the charged particles are co-ions having an identical electric property as the conducting granule and are added into the buffer solution, and while the external electric field is applied on the conducting granule, the counter-ions exit from the nano-pores or nano-channels and have a nonuniform concentration on the surface of the conducting granule such that a transient ion super-concentration phenomenon occurs at an ejecting pole on the conducting granule.

12. The apparatus according to claim 11, comprising an electric double-layer formed on the surface of the conducting granule by the counter-ions.

13. The apparatus according to claim 12, wherein pore sizes of the nano-pores are 3-5 times a thickness of the electric double-layer.

14. The apparatus according to claim 11, wherein the substrate comprises a chip or a plastic plate.

15. The apparatus according to claim 11, wherein the conducting granule comprises a cation exchange resin granule or an anion exchange resin granule.

16. The apparatus according to claim 11, wherein the charged particles comprise solute particles or microparticles.

17. The apparatus according to claim 16, wherein the solute particles comprise fluorescent dye particles and the microparticles comprise micro-colloid particles.

18. The apparatus according to claim 17, wherein the fluorescent dye particles comprise rhodamine B or fluorescein particles.

19. The apparatus according to claim 10, wherein the external electric field is produced by a plurality of electrodes.

20. The apparatus according to claim 10, wherein the apparatus is applicable to a bead-based biomolecular assay.
